(19) United States
(12) Patent Application Publication
(10) Pub. No.: US 2025/0383789 A1
(43) Pub. Date: Dec. 18, 2025

(54) SECURE WRITE PROTECTIONS FOR MEMORY SYSTEMS

(71) Applicant: Micron Technology, Inc., Boise, ID (US)

(72) Inventors: Luca Porzio, Casalnuovo (IT); Filippo Maggio, Paderno Dugnano (IT); Paolo Amato, Treviglio (IT); Dionisio Minopoli, Frattamaggiore (IT); Giuseppe Ferrari, Napoli (IT)

(21) Appl. No.: 19/233,614

(22) Filed: Jun. 10, 2025

Related U.S. Application Data
(60) Provisional application No. 63/659,453, filed on Jun. 13, 2024.

(51) Int. Cl. G06F 3/06

(52) U.S. Cl. CPC G06F 3/0622; G06F 3/0637; G06F 3/0673

(57) ABSTRACT

Methods, systems, and devices for secure write protections for memory systems are described. A memory system may configure a region of a block of the memory system, where configuring the region of the block may include configuring a starting logical block address (LBA) of the block and a quantity of logical blocks from the starting LBA within the block. Based on configuring the region, the memory system may configure one or more parameters associated with the region, such as configuring a mode of operation associated with the region, a write threshold associated with the region, or both, where the write threshold associated with the region may be based on the mode of operation. Accordingly, the memory system may implement a secure write protect procedure for a region of memory based on satisfaction of the write thresholds, configuring the region, or both.

### CROSS REFERENCE

The present Application for Patent claims priority to U.S. Patent Application No. 63/659,453 by Porzio et al., entitled “SECURE WRITE PROTECTIONS FOR MEMORY SYSTEMS,” filed Jun. 13, 2024, which is assigned to the assignee hereof, and which is expressly incorporated by reference in its entirety herein.

### TECHNICAL FIELD

The following relates to one or more systems for memory, including secure write protections for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports secure write protections for memory systems in accordance with examples as disclosed herein.

FIG. 2 shows an example of a system that supports secure write protections for memory systems in accordance with examples as disclosed herein.

FIG. 3 shows a block diagram of a memory system that supports secure write protections for memory systems in accordance with examples as disclosed herein.

FIG. 4 shows a flowchart illustrating a process or processes (e.g., a method or methods) that support secure write protections for memory systems in accordance with examples as disclosed herein.

### DETAILED DESCRIPTION

Some memory systems may implement a secure write protection procedure to enable the memory systems to store data to one or more regions of memory in an authenticated and replay-protected manner. For example, during the secure write projection procedure, a memory system may verify, using an authentication key, whether access requests (from a host system) directed to the one or more regions of memory are allowed, and if not, proceed to disallow access to the one or more regions of memory. In this way, the memory system may protect the data stored in the one or more regions of memory from malicious or faulty access requests. To implement such functionality, a memory system may declare (e.g., allocate, configure) that a region of the memory system (e.g., one or more logical blocks of virtual block) is associated with the secure write protection procedure, where based on (e.g., in response to) declaring the region, the memory system may implement the secure write protection procedure for the region. In some cases, however, one or more users of the memory system may desire to control the timing of the implementation of the secure write protection procedure at the declared region (e.g., implement the secure write protection procedure at the declared region at a time after the declaration). Thus, techniques to enable users of the memory system control of the timing of the secure write protection procedure may be desired.

The techniques described herein may enable the memory system to implement the secure write protect procedure for a region of memory based on (e.g., in response to) satisfaction of one or more write thresholds at the declared region of memory. For example, the memory system may configure (e.g., declare) a region of a block (e.g., virtual block) of the memory system, where configuring the region of the block may include configuring a starting logical block address (LBA) of the block and a quantity of logical blocks from the starting LBA within the block. Based on (e.g., in response to) configuring the region, the memory system may configure one or more parameters associated with the region, such as configuring a mode of operation associated with the region, a write threshold associated with the region, or both (among other example options), where the write threshold associated with the region may be based on (e.g., interpreted according to) the mode of operation. Accordingly, the memory system may implement the secure write protection procedure for the configured region based on (e.g., in response to) the satisfaction of the write threshold associated with the region.

For example, in a first mode of operation (e.g., 00), the memory system may implement the secure write protect procedure for the region based on (e.g., in response to) configuring (e.g., declaring) the region. In a second mode of operation (e.g., 01), the write threshold may correspond to a threshold percentage of predicted lifetime at the region, where the memory system may implement the secure write protection procedure based on (e.g., in response to) a percentage of predicted lifetime at the region satisfying the threshold. In a third mode of operation (e.g., 10), the threshold may correspond to a threshold quantity of bytes written to the region, where the memory system may implement the secure write protection procedure based on (e.g., in response to) a quantity of bytes of data written to the region satisfying the threshold quantity of bytes. In a fourth mode of operation (e.g., 11), the write threshold may correspond to a threshold quantity of bytes available to be written to the region, where the memory system may implement the secure write protection procedure based on (e.g., in response to) an available quantity of bytes in the region satisfying the threshold quantity of bytes available. In some examples, one or more of the different modes of operation described may be used together or in any various combination(s). In this way, by setting the mode of operation and write threshold associated with the region, a user (e.g., via a host system) of the memory system may control the timing for implementing the secure write protection procedure at the region.

In addition to applicability in memory systems described herein, techniques for secure write protections for memory systems may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by protecting regions of memory under various conditions and may prevent or mitigate unauthorized access to data or other information. This may provide improved security and authentication for memory devices and systems, among other benefits.

Features of the disclosure are illustrated and described in the context of systems, devices, and circuits. Features of the disclosure are further illustrated and described in the context of flowcharts.

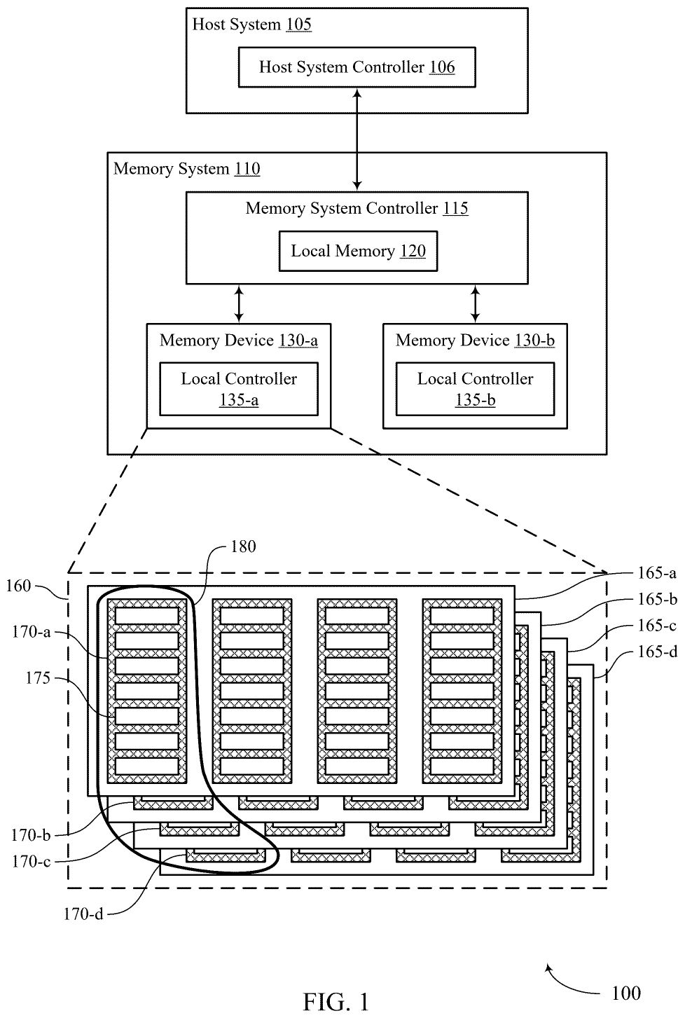

FIG. 1 shows an example of a system 100 that supports secure write protections for memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some systems, a memory device may be subject to wear due to multiple write accesses (e.g., due to faulty systems or malicious activity). This may result in unreliable memory cells at the memory device, causing issues for applications using the region of the block. Such applications may include security or safety applications for a device, resulting in potentially increased danger and decreased security for users. Thus, solutions which allow a memory system to mitigate such memory cell issues are desirable.

The memory system 110 may implement a secure write protection procedure to store data to one or more regions of memory in an authenticated and replay-protected manner. For example, during the secure write projection procedure, a memory system 110 may verify, using an authentication key, whether access requests (from a host system) directed to the one or more regions of memory are allowed, and if not, proceed to disallow access to the one or more regions of memory. In this way, the memory system 110 may protect the data stored in the one or more regions of memory from malicious or faulty access requests. To implement such functionality, a memory system 110 may declare (e.g., allocate or configure) that a region of the memory system 110 (e.g., one or more logical blocks of a virtual block 180) is associated with the secure write protection procedure, where based on (e.g., in response to) declaring the region, the memory system 110 may implement the secure write protection procedure for the region. In some cases, however, one or more users of the memory system 110 may desire to control the timing of the implementation of the secure write protection procedure at the declared region (e.g., implement the secure write protection procedure at the declared region at a time after the declaration). Thus, techniques to enable users of the memory system 110 control of the timing of the secure write protection procedure may be desired.

The techniques described herein may enable the memory system 110 to implement the secure write protect procedure for a region of memory based on (e.g., in response to) satisfaction of one or more write thresholds at the declared region of memory. For example, the memory system 110 may configure (e.g., declare) a region of the virtual block 180 of the memory system 110, where configuring the region of the block may include configuring a starting LBAs of the block and a quantity of logical blocks from the starting LBA within the virtual block 180. Based on (e.g., in response to) configuring the region, the memory system 110 may configure one or more parameters associated with the region, such as configuring a mode of operation associated with the region, a write threshold associated with the region, or both, where the write threshold associated with the region may be based on (e.g., interpreted according to) the mode of operation. Accordingly, the memory system 110 may implement the secure write protection procedure for the configured region based on (e.g., in response to) the satisfaction of the write threshold associated with the region.

For example, in a first mode of operation (e.g., 00), the memory system 110 may implement the secure write protect procedure for the region based on (e.g., in response to) configuring (e.g., declaring) the region. In a second mode of operation (e.g., 01), the write threshold may correspond to a threshold percentage of predicted lifetime at the region, where the memory system 110 may implement the secure write protection procedure based on (e.g., in response to) a percentage of predicted lifetime at the region satisfying the threshold. In a third mode of operation (e.g., 10), the threshold may correspond to a threshold quantity of bytes written to the region, where the memory system 110 may implement the secure write protection procedure based on (e.g., in response to) a quantity of bytes of data written to the region satisfying the threshold quantity of bytes. In a fourth mode of operation (e.g., 11), the write threshold may correspond to a threshold quantity of bytes available to be written to the region, where the memory system 110 may implement the secure write protection procedure based on (e.g., in response to) an available quantity of bytes in the region satisfying the threshold quantity of bytes available. In this way, by setting the mode of operation and write threshold associated with the region, a user (e.g., via a host system) of the memory system 110 may control the timing for implementing the secure write protection procedure at the region.

The system 100 may include any quantity of non-transitory computer readable media that support secure write protections for memory systems. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

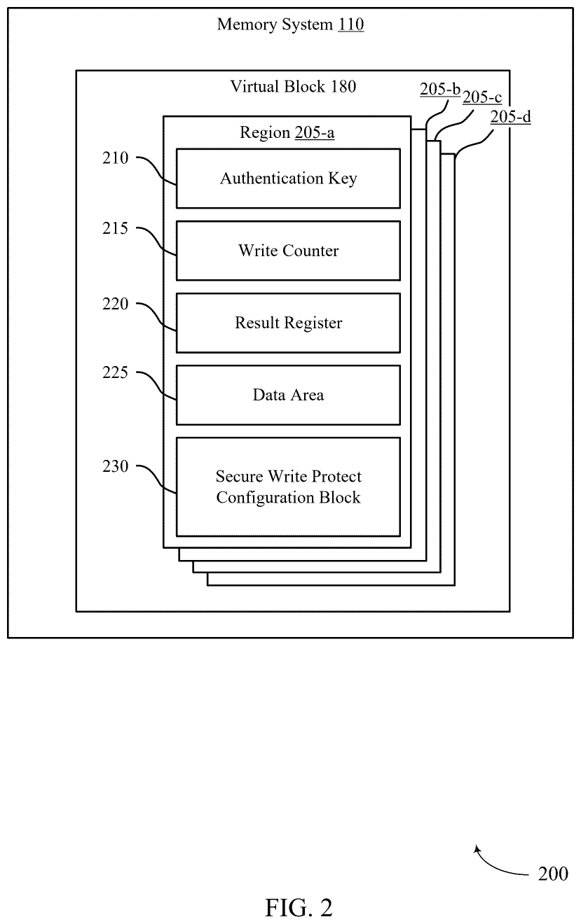

FIG. 2 shows an example of a system 200 that supports secure write protections for memory systems in accordance with examples as disclosed herein. In some cases, the system 200 may implement or be implemented by aspects of the system 100. For example, the system 200 may include a memory system 110, which may include one or more virtual blocks, such as a virtual block 180 (e.g., a logical block) as described herein. In the following description, although some operations are described to be performed by the memory system 110, these operations may be performed by a component of the memory system 110 (e.g., a memory system controller 115, a memory device 130, or a local controller 135-a). Further, although some operations and procedures are described with respect to a region 205-a, these operations may also be applied to other regions 205.

In some implementations, the virtual block 180 may be a replay-protected memory block (RPMB) and include one or more regions 205 (e.g., memory regions of a virtual block), such as the region 205-a, 205-b, 205-c, and/or 205-d. Each region 205 of the one or more regions 205 may be associated with an authentication key 210, a write counter 215, a result register 220, or any combination thereof. Additionally, each region 205 may include a data area 225, a configuration block 230 (e.g., a secure write protect configuration block), or both. The authentication key 210 may be written once (e.g., not erasable or readable) to the region 205 and be used to authenticate access requests (e.g., write or read accesses) directed to the region 205. In some cases, the memory system 110 may use the authentication key 210 to sign read or write accesses at a protected area (e.g., the region 205-a) of the memory device 130 with a message authentication code (MAC). For example, the memory system 110 may apply the authentication key 210 to verify accesses after the memory system 110 calculates the MAC.

The write counter 215 may be read-only and may track a total quantity of successful authenticated write requests made by a host system 105. The result register 220 may be read from (e.g., “read only”) and may provide a result of an authenticated operation (e.g., indicating whether an access is authenticated). The data area 225 may be readable and writable and may include data which can be read or written to via successfully authenticated read or write access. The configuration block 230 may be readable and writable and may include one or more parameters associated with the respective region 205.

In some implementations, the memory system 110 may configure (e.g., program or write) one or more secure write entries at the configuration block 230. For example, the memory system 110 may configure the region 205-a by setting one or more bits to respective values in a secure write protect entry, represented by Table 1, which includes multiple bytes (e.g., 16 bytes). In some examples, the memory system 110 may receive one or more write commands from the host system 105 that configures the values of the secure write protect entry.

In some cases, the memory system 110 (e.g., via a mode register write from a host system 105) may configure a starting LBA of the region 205-a by setting the corresponding bytes of the secure write protect entry. For example, the memory system 110 may store the starting LBA in a first set of bytes (e.g., bytes 4-11) of the secure write protect entry. Similarly, the memory system 110 may configure (e.g., via the mode register write from the host system 105) a quantity of logical blocks of the region 205-a by storing setting a second set of bytes (e.g., bytes 12-15) of the secure write protect entry. The starting LBA and the quantity of logical blocks may define the region 205-a. For example, the starting LBA may represent a first LBA of the region 205-a, and the quantity of logical blocks may correspond to a size (e.g., in logical blocks) of the region 205-a.

TABLE 1
Secure Write Protect Entry

| | Bit | | | | | | | |
|---|---|---|---|---|---|---|---|---|
| Byte | 7 | 6 | 5 | 4 | 3 | 2 | 1 | 0 |
| 0 | Reserved | | | Mode of Operation | | WPT | | WPF |
| 1 | Reserved | | | | | | | |
| 2 | Write Threshold | | | | | | | |
| 3 | | | | | | | | |
| 4 | (MSB) | | | | | | | |
| . . . | LOGICAL BLOCK ADDRESS | | | | | | | |
| 11 | | | | | | | | (LSB) |
| 12 | (MSB) | | | | | | | |
| . . . | QUANTITY OF LOGICAL BLOCKS | | | | | | | |
| 15 | | | | | | | | (LSB) |

In accordance with the techniques described herein, the memory system 110 may configure (e.g., via the mode register write from the host system 105) one or more parameters such as a mode of operation, a write threshold, or both, at a subset of any of the reserved bits, which may enable the user of the memory system 110 to control the timing of the implementation of the secure write protect procedure at the regions 205. For example, the memory system 110 may store the mode of operation associated with the regions 205 at a first set of bits (e.g., bits 3 and 4 of byte 0), of the secure write protect entry. Similarly, the memory system 110 may store the write threshold associated with the regions 205 at a second set of bits, such as across two bytes (e.g., bytes 2 and 3 of the secure write protect entry). In some examples, the write threshold may be referred to as a lifetime parameter.

As described herein, the mode of operation and the write threshold may be associated with the configured region 205. In some examples, the write threshold associated with the region 205-a may be based on (e.g., interpreted according to, or defined by) the mode of operation associated with the region 205-a. That is, a value or measurement associated with the write threshold may vary according to the mode of operation, such that the memory system 110 determine the value or measurement associated with the write threshold according to the mode of operation. In such examples, the memory system 110 may implement the secure write protect procedure for the region 205-a based on (e.g., in response to) the satisfaction of the write threshold.

In one example, the memory system 110 may store a first value (e.g., ‘00’) corresponding to a first mode of operation, where, according to the first mode of operation, the memory system 110 may implement the secure write protect procedure at the region 205-a based on (e.g., in response to) configuration of the region 205-a (e.g., write protect configuration may be immediate, or implemented immediately in response to configuring the region 205-a). In such examples, the memory system 110 may refrain from using the value written to the bytes of the secure write protect entry that are associated with the write threshold.

In another example, the memory system 110 may store a second value (e.g., ‘01’) corresponding to a second mode of operation, where, according to the second mode of operation, the write threshold may represent (e.g., correspond to, be defined as, or interpreted as) a threshold percentage of predicted lifetime of the region 205-a. For example, to measure the lifetime of the region 205-a, the memory system 110 may determine a quantity of program erase cycles (PECs) that have occurred at the region 205-a. A PEC may refer to an event of writing a memory cell from the programmed state to the erased state and back to the programmed state (e.g., writing a “new” value to a memory cell). Accordingly, the threshold percentage of predicted lifetime at the region 205-a may correspond to a threshold quantity of PECs performed at the region 205-a. As such, while operating according to the second mode of operation, the memory system 110 may implement the secure write protect procedure at the region 205-a based on (e.g., in response to) a quantity of PECs at the region 205-a (e.g., corresponding to a lifetime percentage of the region 205-a) satisfying (e.g., reaching, being equal to or greater than) the threshold quantity of PECs (e.g., corresponding to the threshold percentage of predicted lifetime).

In some examples, the memory system 110 may store a third value (e.g., ‘10’) corresponding to a third mode of operation, where, according to the third mode of operation, the write threshold may represent (e.g., correspond to, be defined as, or interpreted as) a threshold quantity of bytes of data written to the region 205-a (e.g., total byte written (TBW) in gigabytes (GB)). Accordingly, the memory system 110 may implement the secure write protect procedure at the region 205-a based on (e.g., in response to) a quantity of bytes of data written to the region 205-a satisfying (e.g., being greater than or equal to) the threshold quantity of bytes.

In some examples, the memory system 110 may store a fourth value (e.g., ‘11’) corresponding to a fourth mode of operation, where, according to the fourth mode of operation, the write threshold may represent (e.g., correspond to, be defined as, or interpreted as) a threshold quantity of bytes available to be written to the region 205-a (e.g., in GB). In such examples, the threshold quantity of bytes available to be written to the region 205-a may correspond to a size of the region 205-a for which the memory system 110 is not able to guarantee the validity or accuracy of the data. Accordingly, the memory system 110 may implement the secure write protect procedure at the region 205-a based on (e.g., in response to) a quantity of bytes available to be written to the region 205-a satisfying (e.g., being equal to or less than) the threshold quantity of bytes available to be written to the region 205-a.

In some examples, the memory system 110 (in response to one or more commands from the host system 105 or in response to a determination at the memory system 110) may dynamically switch between modes of operation. For example, the memory system 110 may operate the region 205-a according to the third mode of operation (e.g., ‘10’) and dynamically switch to operate the region 205-a according to the second mode of operation (e.g., ‘01’). In such examples, the memory system 110 may determine to update the write threshold in response to switching from the first mode of operation to the second mode of operation, such that the value of the write threshold is updated according to the mode of operation.

As described herein, a secure write protect procedure (e.g., an authenticated data write sequence) may refer to a procedure in which the memory system 110 may authenticate or prohibit a write access (e.g., a write request, command, or operation) at a particular region 205. Implementing the secure write protect procedure may refer to the memory system 110 beginning to execute such authentication for each write access at the particular region 205.

For example, an initiator (e.g., a host system 105) may send the first command with a first field (e.g., a SECURITY PROTOCOL field) set to a value corresponding to UFS (e.g., ECh) and indicating an RPMB region in a second field (e.g., a SECURITY PROTOCOL SPECIFIC field). The RPMB message may include one or more RPMB message data frames, where each message data frame (e.g., corresponding to a region 205) may include a Request Message Type (e.g., ‘0003h’), a Block Count, an Address, a Write Counter, a Nonce, a Data field, a MAC, or any combination thereof.

Based on receiving the RPMB message, the memory system 110 may determine whether the write counter has expired. If the memory system determines (e.g., detects) that the write counter has expired, the memory system 110 may set a result (e.g., in the result register 220) to “Write failure, write counter expired” (e.g., ‘0085h’). Accordingly, the memory system 110 may refrain from writing to the data area 225 (e.g., the RPMB data area).

Then, the memory system 110 may check the address received via the first command. If the address value is greater than equal to a size of a target RPMB region (e.g., defined as bRPMBRegion0Size-bRPMBRegion3Size parameter value in a corresponding RPMB Unit Descriptor), then the memory system 110 may set the result to “Address failure” (e.g., ‘0004h’) and may refrain from writing to the data area 225. If a sum of the Address value and the Block Count value is greater than the size of target RPMB region, the memory system 110 may set the result to “address failure” and may similarly refrain from writing to the data area 225. If the Block Count indicates a value greater than a threshold read-write size (e.g., bRPMB_ReadWriteSize), then the authenticated data write operation fails and the memory system 110 may set the result to “General failure” (e.g., ‘0001h’).

If the memory system 110 determines (e.g., detects) that the write counter has not expired, the memory system 110 may calculate the MAC of request type, block count, write counter, address and data, and may compare the MAC (e.g., associated with the memory device 130, the region 205, or both) with the MAC in the request. If the two MACs are different, then the memory system 110 may set the result to “Authentication failure” (e.g., ‘0002h’). Accordingly, the memory system 110 may refrain from writing data to the data area 225. If the MAC in the request and the calculated MAC are equal (e.g., the same), the memory system 110 may compare the write counter in the request with the write counter stored in the device (e.g., the write counter 215). If the two counters are different, the memory system 110 may set the result to “Counter failure” (e.g., ‘0003h’) and may refrain from writing data to the data arca 225. If the MAC comparison and the write counter comparison are successful (e.g., if the MACs are equal and the write counters are the equal, or the same) the memory system 110 may determine the write request to be authenticated (e.g., the write request is considered to be authenticated). Accordingly, the memory system may write the data (e.g., the data in the request) to the address indicated in the request (e.g., the address indicating a location in memory within the data arca 225).

In some implementations, the memory system 110 may increment the write counter 215 (e.g., by one) if the write operation was successfully executed. If the write failed (e.g., if the write could not be successfully executed), the memory system 110 may return the result “Write failure” (e.g., ‘0005h’). If another error occurs during the write procedure (e.g., the write operation), the memory system 110 may return the result “General failure” (e.g., ‘0001h’).

In some cases, the memory system may receive a write request (e.g., an authenticated data write request) with a block count greater than one. In some cases, such a write request (or similar write request) may include a MAC in the last data frame (e.g., RPMB message data frame). Each other (previous) data frame may include a MAC field with a value of zero (e.g., device behavior may be undefined if a MAC field is non-zero in any data frame that is not the last RPMB message data frame). Within each data frame, a write counter may indicate the current counter value, an address may indicate the start address of the full access (e.g., rather than an address of the individual logical block), and a block count may indicate a total count of the blocks (e.g., rather than the block numbers). In any case, if the authenticated data write operation is completed, the memory system 110 may return a GOOD status in response to the first command regardless of whether the Authenticated data write was successful.

In some examples, in response to performing the secure write protection procedure, the memory system 110 may perform an authentication procedure (e.g., an authenticated data write verification process). For example, an initiator (e.g., a host system 105) may send a first command (e.g., SECURITY PROTOCOL OUT) with a first field (e.g., a SECURITY PROTOCOL field) set to ‘ECh’. The command may also indicate the region to be written to (e.g., the RPMB region) in a second field (e.g., a SECURITY PROTOCOL SPECIFIC) field. The RPMB data frame may contain the Request Message Type “Result read request” (e.g., ‘0005h’). In some examples, any request other than the Result read request from an initiator may overwrite the Result register of the region (e.g., result register 220). The memory system 110 may return a ready status (e.g., a GOOD status) if (e.g., after) the operation result is ready for retrieval (e.g., ready to be read).

An initiator may retrieve the operation result by issuing a second command (e.g., a SECURITY PROTOCOL IN) command. A first field (e.g., a SECURITY PROTOCOL field) of the second command may be set to ‘ECh’ and a second field (e.g., a SECURITY PROTOCOL SPECIFIC field) of the second command may indicate the region 205. The memory system 110 may return the data frame (e.g., the RPMB data frame) that includes the response message type (e.g., ‘0300h’), the counter value (e.g., from the write counter 215, incremented if the write operation is successfully executed), a copy of the Nonce received in the request, the address received in the authenticated data write request, the MAC, and the result of the authenticated data write operation (e.g., in the result register 220).

By implementing the techniques described herein, the memory system 110 may maintain (e.g., reserve) a portion of memory for one or more security, safety, or other applications, while also enabling a user of the memory system 110 to control the timing of the implementation of the secure write protection procedure at the region 205-a. As such, the memory system 110 may block accesses to the region 205-a during an end-of-life of the region 205-a and maintain the accuracy of the data stored at the region 205-a (e.g., guarantee write operations).

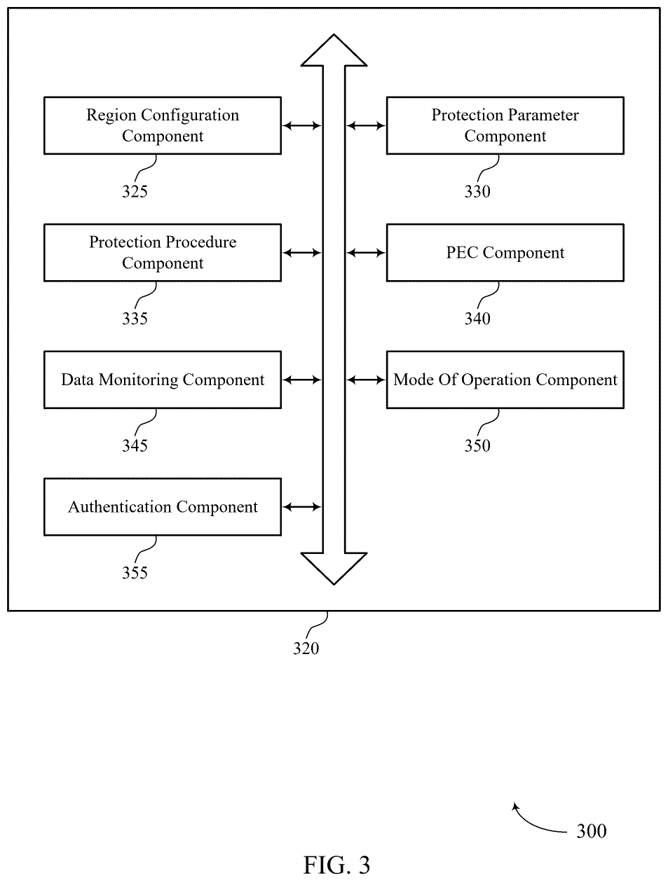

FIG. 3 shows a block diagram 300 of a memory system 320 that supports secure write protections for memory systems in accordance with examples as disclosed herein. The memory system 320 may be an example of aspects of a memory system as described with reference to FIGS. 1 through 2. The memory system 320, or various components thereof, may be an example of means for performing various aspects of secure write protections for memory systems as described herein. For example, the memory system 320 may include a region configuration component 325, a protection parameter component 330, a protection procedure component 335, a PEC component 340, a data monitoring component 345, a mode of operation component 350, an authentication component 355, or any combination thereof. Each of these components, or components of subcomponents thereof (e.g., one or more processors, one or more memories), may communicate, directly or indirectly, with one another (e.g., via one or more buses).

The region configuration component 325 may be configured as or otherwise support a means for configuring a region of a block of the memory system, the region including a starting logical block address of the block and a quantity of logical blocks from the starting logical block address of the block. The protection parameter component 330 may be configured as or otherwise support a means for configuring one or more parameters associated with the region, the one or more parameters including a mode of operation, a write threshold, or both, where the write threshold is based at least in part on the mode of operation associated with the region. The protection procedure component 335 may be configured as or otherwise support a means for implementing a secure write protection procedure for the region based at least in part on configuring the one or more parameters.

In some examples, the mode of operation indicates that the memory system is to implement the secure write protection procedure based at least in part on configuring the region, and the protection procedure component 335 may be configured as or otherwise support a means for implementing the secure write protection procedure based at least in part on configuring the region of the block.

In some examples, the mode of operation indicates that the write threshold is a threshold quantity of PECs performed on the region, and the PEC component 340 may be configured as or otherwise support a means for monitoring a quantity of PECs performed on the region. In some examples, the mode of operation indicates that the write threshold is a threshold quantity of PECs performed on the region, and the protection procedure component 335 may be configured as or otherwise support a means for implementing the secure write protection procedure for the region based at least in part on the quantity of PECs performed on the region satisfying the threshold quantity of PECs.

In some examples, the threshold quantity of PECs corresponds to a threshold percentage of predicted lifetime for the region. In some examples, the quantity of PECs corresponds to a percentage of predicted lifetime for the region.

In some examples, the mode of operation indicates that the write threshold is a threshold quantity of bytes written to the region, and the data monitoring component 345 may be configured as or otherwise support a means for monitoring a quantity of bytes of data written to the region. In some examples, the mode of operation indicates that the write threshold is a threshold quantity of bytes written to the region, and the protection procedure component 335 may be configured as or otherwise support a means for implementing the secure write protection procedure for the region based at least in part on the quantity of bytes of data written to the region satisfying the threshold quantity of bytes.

In some examples, the mode of operation indicates that the write threshold is a threshold quantity of bytes available to be written to the region, and the protection procedure component 335 may be configured as or otherwise support a means for implementing the secure write protection procedure for the region based at least in part on an available quantity of bytes in the region satisfying the threshold quantity of bytes available at the region.

In some examples, the mode of operation component 350 may be configured as or otherwise support a means for switching the mode of operation associated with the region from a first mode of operation to a second mode of operation, the first mode of operation being associated with a first type of the write threshold and the second mode of operation being associated with a second type of the write threshold, where implementing the secure write protection procedure is based at least in part on switching the mode of operation associated with the region.

In some examples, to support secure write protection procedure, the authentication component 355 may be configured as or otherwise support a means for determining whether to prohibit or allow an authenticated data write command to access the region based at least in part on a first message authentication code (MAC) included in the authenticated data write command and a second MAC associated with the region.

In some examples, to support whether to prohibit or allow the authenticated data write command to access the region, the authentication component 355 may be configured as or otherwise support a means for determining to prohibit access to the region based at least in part on the first MAC being different from the second MAC.

In some examples, to support whether to prohibit or allow the authenticated data write command to access the region, the authentication component 355 may be configured as or otherwise support a means for determining to allow access to the region based at least in part on the first MAC being equal to the second MAC.

In some examples, the block includes a replay-protected memory block (RPMB). In some examples, the region of the block includes a RPMB region.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

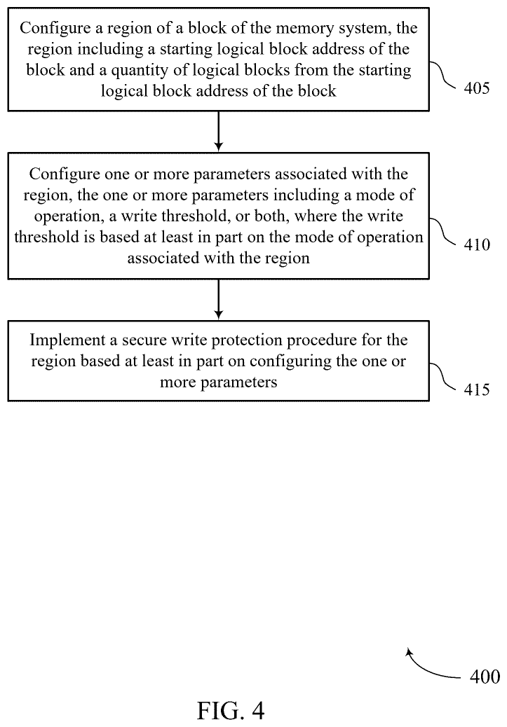

FIG. 4 shows a flowchart illustrating a process 400 that supports secure write protections for memory systems in accordance with examples as disclosed herein. The operations of process 400 may be implemented by a memory system or its components as described herein. For example, the operations of process 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the process may include configuring a region of a block of the memory system, the region including a starting logical block address of the block and a quantity of logical blocks from the starting logical block address of the block. In some examples, aspects of the operations of 405 may be performed by a region configuration component 325 as described with reference to FIG. 3.

At 410, the process may include configuring one or more parameters associated with the region, the one or more parameters including a mode of operation, a write threshold, or both, where the write threshold is based at least in part on the mode of operation associated with the region. In some examples, aspects of the operations of 410 may be performed by a protection parameter component 330 as described with reference to FIG. 3.

At 415, the process may include implementing a secure write protection procedure for the region based at least in part on configuring the one or more parameters. In some examples, aspects of the operations of 415 may be performed by a protection procedure component 335 as described with reference to FIG. 3.

In some examples, an apparatus as described herein may perform a process or methods, such as the process 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for configuring a region of a block of the memory system, the region including a starting logical block address of the block and a quantity of logical blocks from the starting logical block address of the block; configuring one or more parameters associated with the region, the one or more parameters including a mode of operation, a write threshold, or both, where the write threshold is based at least in part on the mode of operation associated with the region; and implementing a secure write protection procedure for the region based at least in part on configuring the one or more parameters.

Aspect 2: The method, apparatus, or non-transitory computer-readable medium of aspect 1, where the mode of operation indicates that the memory system is to implement the secure write protection procedure based at least in part on configuring the region and the method, apparatuses, and non-transitory computer-readable medium further includes operations, features, circuitry, logic, means, or instructions, or any combination thereof for implementing the secure write protection procedure based at least in part on configuring the region of the block.

Aspect 3: The method, apparatus, or non-transitory computer-readable medium of any of aspects 1 through 2, where the mode of operation indicates that the write threshold is a threshold quantity of PECs performed on the region and the method, apparatuses, and non-transitory computer-readable medium further includes operations, features, circuitry, logic, means, or instructions, or any combination thereof for monitoring a quantity of PECs performed on the region and implementing the secure write protection procedure for the region based at least in part on the quantity of PECs performed on the region satisfying the threshold quantity of PECs.

Aspect 4: The method, apparatus, or non-transitory computer-readable medium of aspect 3, where the threshold quantity of PECs corresponds to a threshold percentage of predicted lifetime for the region and the quantity of PECs corresponds to a percentage of predicted lifetime for the region.

Aspect 5: The method, apparatus, or non-transitory computer-readable medium of any of aspects 1 through 4, where the mode of operation indicates that the write threshold is a threshold quantity of bytes written to the region and the method, apparatuses, and non-transitory computer-readable medium further includes operations, features, circuitry, logic, means, or instructions, or any combination thereof for monitoring a quantity of bytes of data written to the region and implementing the secure write protection procedure for the region based at least in part on the quantity of bytes of data written to the region satisfying the threshold quantity of bytes.

Aspect 6: The method, apparatus, or non-transitory computer-readable medium of any of aspects 1 through 5, where the mode of operation indicates that the write threshold is a threshold quantity of bytes available to be written to the region and the method, apparatuses, and non-transitory computer-readable medium further includes operations, features, circuitry, logic, means, or instructions, or any combination thereof for implementing the secure write protection procedure for the region based at least in part on an available quantity of bytes in the region satisfying the threshold quantity of bytes available at the region.

Aspect 7: The method, apparatus, or non-transitory computer-readable medium of any of aspects 1 through 6, further including operations, features, circuitry, logic, means, or instructions, or any combination thereof for switching the mode of operation associated with the region from a first mode of operation to a second mode of operation, the first mode of operation being associated with a first type of the write threshold and the second mode of operation being associated with a second type of the write threshold, where implementing the secure write protection procedure is based at least in part on switching the mode of operation associated with the region.

Aspect 8: The method, apparatus, or non-transitory computer-readable medium of any of aspects 1 through 7, where the secure write protection procedure includes operations, features, circuitry, logic, means, or instructions, or any combination thereof for determining whether to prohibit or allow an authenticated data write command to access the region based at least in part on a first message authentication code (MAC) included in the authenticated data write command and a second MAC associated with the region.

Aspect 9: The method, apparatus, or non-transitory computer-readable medium of aspect 8, where whether to prohibit or allow the authenticated data write command to access the region includes operations, features, circuitry, logic, means, or instructions, or any combination thereof for determining to prohibit access to the region based at least in part on the first MAC being different from the second MAC.

Aspect 10: The method, apparatus, or non-transitory computer-readable medium of any of aspects 8 through 9, where whether to prohibit or allow the authenticated data write command to access the region includes operations, features, circuitry, logic, means, or instructions, or any combination thereof for determining to allow access to the region based at least in part on the first MAC being equal to the second MAC.

Aspect 11: The method, apparatus, or non-transitory computer-readable medium of any of aspects 1 through 10, where the block includes a replay-protected memory block (RPMB) and the region of the block includes a RPMB region.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
configure a region of a block of the memory system, the region comprising a starting logical block address of the block and a quantity of logical blocks from the starting logical block address of the block;
configure one or more parameters associated with the region, the one or more parameters comprising a mode of operation, a write threshold, or both, wherein the write threshold is in accordance with the mode of operation associated with the region; and
implement a secure write protection procedure for the region in accordance with configuring the one or more parameters.

2. The memory system of claim 1, wherein the mode of operation indicates that the memory system is to implement the secure write protection procedure in response to configuring the region, and the processing circuitry is further configured to cause the memory system to:
implement the secure write protection procedure in response to configuring the region of the block.

3. The memory system of claim 1, wherein the mode of operation indicates that the write threshold is a threshold quantity of program erase cycles performed on the region, and the processing circuitry is further configured to cause the memory system to:
monitor a quantity of program erase cycles performed on the region; and
implement the secure write protection procedure for the region in response to the quantity of program erase cycles performed on the region satisfying the threshold quantity of program erase cycles.

4. The memory system of claim 3, wherein:
the threshold quantity of program erase cycles corresponds to a threshold percentage of predicted lifetime for the region, and
the quantity of program erase cycles corresponds to a percentage of predicted lifetime for the region.

5. The memory system of claim 1, wherein the mode of operation indicates that the write threshold is a threshold quantity of bytes written to the region, and the processing circuitry is further configured to cause the memory system to:
monitor a quantity of bytes of data written to the region; and
implement the secure write protection procedure for the region in response to the quantity of bytes of data written to the region satisfying the threshold quantity of bytes.

6. The memory system of claim 1, wherein the mode of operation indicates that the write threshold is a threshold quantity of bytes available to be written to the region, and the processing circuitry is further configured to cause the memory system to:
implement the secure write protection procedure for the region in response to an available quantity of bytes in the region satisfying the threshold quantity of bytes available at the region.

7. The memory system of claim 1, wherein the processing circuitry is further configured to cause the memory system to:
switch the mode of operation associated with the region from a first mode of operation to a second mode of operation, the first mode of operation being associated with a first type of the write threshold and the second mode of operation being associated with a second type of the write threshold, wherein implementing the secure write protection procedure is in accordance with switching the mode of operation associated with the region.

8. The memory system of claim 1, wherein, to secure write protection procedure, the processing circuitry is further configured to cause the memory system to:
determine whether to prohibit or allow an authenticated data write command to access the region in accordance with a first message authentication code (MAC) included in the authenticated data write command and a second MAC associated with the region.

9. The memory system of claim 8, wherein, to determine whether to prohibit or allow the authenticated data write command to access the region, the processing circuitry is further configured to cause the memory system to:
determine to prohibit access to the region in response to the first MAC being different from the second MAC.

10. The memory system of claim 8, wherein, to determine whether to prohibit or allow the authenticated data write command to access the region, the processing circuitry is further configured to cause the memory system to:
determine to allow access to the region in response to the first MAC being equal to the second MAC.

11. The memory system of claim 1, wherein:
the block comprises a replay-protected memory block (RPMB), and
the region of the block comprises a RPMB region.

12. A non-transitory computer-readable medium storing code comprising instructions which, when executed by one or more processors of a memory system, cause the memory system to:
configure a region of a block of the memory system, the region comprising a starting logical block address of the block and a quantity of logical blocks from the starting logical block address of the block;
configure one or more parameters associated with the region, the one or more parameters comprising a mode of operation, a write threshold, or both, wherein the write threshold is in accordance with the mode of operation associated with the region; and
implement a secure write protection procedure for the region in accordance with configuring the one or more parameters.

13. The non-transitory computer-readable medium of claim 12, wherein the mode of operation indicates that the memory system is to implement the secure write protection procedure in response to configuring the region, and the instructions, when executed by the one or more processors of the memory system, further cause the memory system to:
implement the secure write protection procedure in response to configuring the region of the block.

14. The non-transitory computer-readable medium of claim 12, wherein the mode of operation indicates that the write threshold is a threshold quantity of program erase cycles performed on the region, and the instructions, when executed by the one or more processors of the memory system, further cause the memory system to:
monitor a quantity of program erase cycles performed on the region; and
implement the secure write protection procedure for the region in response to the quantity of program erase cycles performed on the region satisfying the threshold quantity of program erase cycles.

15. The non-transitory computer-readable medium of claim 12, wherein the mode of operation indicates that the write threshold is a threshold quantity of bytes written to the region, and the instructions, when executed by the one or more processors of the memory system, further cause the memory system to:
monitor a quantity of bytes of data written to the region; and
implement the secure write protection procedure for the region in response to the quantity of bytes of data written to the region satisfying the threshold quantity of bytes.

16. The non-transitory computer-readable medium of claim 12, wherein the mode of operation indicates that the write threshold is a threshold quantity of bytes available to be written to the region, and the instructions, when executed by the one or more processors of the memory system, further cause the memory system to:
implement the secure write protection procedure for the region in response to an available quantity of bytes in the region satisfying the threshold quantity of bytes available at the region.

17. The non-transitory computer-readable medium of claim 12, wherein the instructions, when executed by the one or more processors of the memory system, further cause the memory system to:
switch the mode of operation associated with the region from a first mode of operation to a second mode of operation, the first mode of operation being associated with a first type of the write threshold and the second mode of operation being associated with a second type of the write threshold, wherein implementing the secure write protection procedure is in accordance with switching the mode of operation associated with the region.

18. The non-transitory computer-readable medium of claim 12, wherein the instructions, when executed by the one or more processors of the memory system, further cause the memory system to:
determine whether to prohibit or allow an authenticated data write command to access the region in accordance with a first message authentication code (MAC) included in the authenticated data write command and a second MAC associated with the region.

19. A method at a memory system, comprising:
configuring a region of a block of the memory system, the region comprising a starting logical block address of the block and a quantity of logical blocks from the starting logical block address of the block;
configuring one or more parameters associated with the region, the one or more parameters comprising a mode of operation, a write threshold, or both, wherein the write threshold is based at least in part on the mode of operation associated with the region; and
implementing a secure write protection procedure for the region in accordance with configuring the one or more parameters.

20. The method of claim 19, wherein the mode of operation indicates that the memory system is to implement the secure write protection procedure in response to configuring the region, the method further comprising:
implementing the secure write protection procedure in response to configuring the region of the block.

21. The method of claim 19, wherein the mode of operation indicates that the write threshold is a threshold quantity of program erase cycles performed on the region, the method further comprising:
monitoring a quantity of program erase cycles performed on the region; and
implementing the secure write protection procedure for the region in response to the quantity of program erase cycles performed on the region satisfying the threshold quantity of program erase cycles.

22. The method of claim 19, wherein the mode of operation indicates that the write threshold is a threshold quantity of bytes written to the region, the method further comprising:
monitoring a quantity of bytes of data written to the region; and
implementing the secure write protection procedure for the region in response to the quantity of bytes of data written to the region satisfying the threshold quantity of bytes.
